(19) United States
(12) Patent Application Publication
(10) Pub. No.: US 2022/0165516 A1
(43) Pub. Date: May 26, 2022

(54) PUSH SWITCH

(71) Applicant: Panasonic Intellectual Property Management Co., Ltd., Osaka (JP)

(72) Inventor: Kunio DORO, Okayama (JP)

(21) Appl. No.: 17/602,522

(22) PCT Filed: Feb. 17, 2020
(86) PCT No.: PCT/JP2020/006119

§ 371 Date: Oct. 8, 2021

(30) Foreign Application Priority Data
Apr. 10, 2019 (JP) 2019-075149

(51) Int. Cl. H01H 13/14; H01H 13/20; H01H 13/04

(52) U.S. Cl. CPC H01H 13/14; H01H 13/04; H01H 13/20

(57) ABSTRACT

A push switch includes a case, a fixed contact member, a moving contact member, a first protective sheet, and a second protective sheet. The case has a first surface with a recess opened and a second surface opposite from the first surface. The fixed contact member includes a fixed contact in the recess and a terminal on an outer surface of the case. The moving contact member is in the recess and includes a moving contact to contact with the fixed contact through a press operation. The first protective sheet is provided for the first surface to cover the recess. The second protective sheet covers the second surface. The first protective sheet is welded to the first surface with a first welded portion surrounding an entire circumference of the recess. The second protective sheet is welded to the second surface with a second welded portion.

### TECHNICAL FIELD

The present disclosure generally relates to a push switch, and more particularly relates to a push switch configured to turn ON/OFF depending on whether or not a press operation is performed thereon.

### BACKGROUND ART

A push switch is disclosed in Patent Literature 1. The push switch includes: a case which is made of a molding resin; a plurality of fixed contacts; and a moving contact. The plurality of fixed contacts are provided in the case. The moving contact brings the plurality of fixed contacts into/out of contact with each other.

In Patent Literature 1, the fixed contacts are fixed to the case by insert molding. The case has pin holes. The pin holes are holes left by pulling supporting pins out and are opened in a direction in which the pins have been pulled out. The supporting pins support the fixed contacts during the insert molding. In addition, an insulating sheet covers the pin holes from over the openings.

In the push switch of Patent Literature 1, an insulating sheet is attached to the case with a pressure sensitive adhesive layer. Nevertheless, from the viewpoint of waterproofness, there is room for further improvement.

### CITATION LIST

### Patent Literature

Patent Literature 1: JP 2013-191482 A

### SUMMARY OF INVENTION

An object of the present disclosure is to provide a push switch which contributes to improving waterproofness.

A push switch according to an aspect of the present disclosure includes a case, a fixed contact member, a moving contact member, a first protective sheet, and a second protective sheet. The case has a first surface with a recess opened and a second surface located opposite from the first surface. The fixed contact member includes a fixed contact arranged in the recess and a terminal arranged on an outer surface of the case. The moving contact member is arranged in the recess and includes a moving contact that comes into contact with the fixed contact when the push switch is subjected to a press operation. The first protective sheet is provided for the first surface to cover the recess. The second protective sheet covers the second surface. The first protective sheet is welded to the first surface of the case with a first welded portion surrounding an entire circumference of the recess. The second protective sheet is welded to the second surface of the case with a second welded portion.

### BRIEF DESCRIPTION OF DRAWINGS

FIG. 1 is an exploded perspective view of a push switch according to an exemplary embodiment of the present disclosure;

FIG. 2 is a plan view of the push switch;

FIG. 3 is a plan view of the push switch, from which a first protective sheet, a presser, and a moving contact member are removed;

FIG. 4 is a bottom view of the push switch;

FIG. 5A is a schematic cross-sectional view of the push switch in a state where the push switch is not operated; and

FIG. 5B is a schematic cross-sectional view of the push switch in a state where the push switch is operated.

### DESCRIPTION OF EMBODIMENTS

### (1) Overview

A push switch 1 according to an exemplary embodiment is implemented as what is called a “waterproof switch.” The push switch 1 is used in an operating member of various devices such as mobile telecommunications devices, onboard equipment, and consumer electronic appliances. The push switch 1 is built in the housing of a device, for example, in a state where the push switch 1 is mounted on a printed circuit board. In that case, for example, an operating button is arranged at a position corresponding to the push switch 1 in the housing. This allows the push switch 1 to be indirectly operated via the operating button by having the user press the operating button.

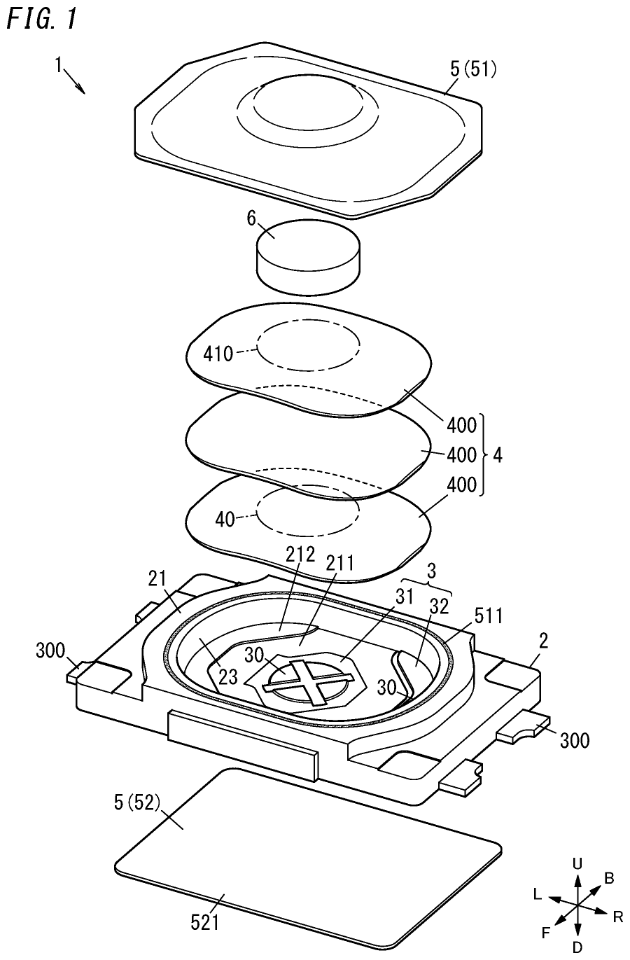

As shown in FIG. 1, the push switch 1 includes a case 2, a fixed contact member 3, a moving contact member 4, a first protective sheet 51, and a second protective sheet 52.

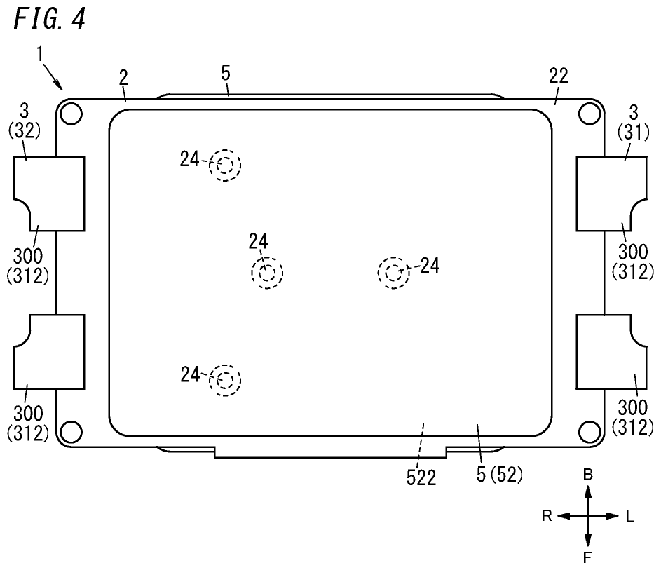

The case 2 has: a first surface 21 with a recess 23 opened; and a second surface 22 which is located opposite from the first surface 21 (see FIG. 4).

The fixed contact member 3 includes: fixed contacts 30 which are arranged in the recess 23; and terminals 300 which are arranged on outer surfaces of the case 2.

The moving contact member 4 is arranged in the recess 23 and includes a moving contact 40 which comes into contact with the fixed contacts 30 when the push switch 1 is subjected to a press operation.

The first protective sheet 51 is provided for the first surface 21 to cover the recess 23. The first protective sheet 51 is welded to the first surface 21 of the case 2 with a first welded portion 511 which surrounds the entire circumference of the recess 23.

The second protective sheet 52 covers the second surface 22. The second protective sheet 52 is welded to the second surface 22 of the case 2 with a second welded portion 521.

The push switch 1 according to this embodiment is provided with the first protective sheet 51 and the second protective sheet 52, and therefore, may have its waterproofness improved. In particular, providing the second protective sheet 52 as an additional sheet for the push switch 1 may reduce the chances of water, flux, and foreign other substances entering the recess 23 from the second surface 22 of the case 2.

### (2) Details

### (2.1) First embodiment

In the following description, unless otherwise stated, a surface on which the recess 23 is provided of the case 2 will be hereinafter referred to as “upper surface” (first surface 21) of the case 2. A depth direction defined with respect to the recess 23 will be hereinafter referred to as an “upward/downward direction.” The direction in which first terminals 312 and second terminals 322 protrude from the case 2 will be hereinafter defined as a “rightward/leftward direction,” and the direction perpendicular to both the upward/downward direction and the rightward/leftward direction will be hereinafter defined as a “forward/backward direction.” In this description, the upward, downward, leftward, rightward, forward, and backward directions are defined just as respectively indicated by the “U,” “D,” “L,” “R,” “F,” and “B” arrows in FIG. 1 and other drawings. Note that these arrows indicating the respective directions do not define the directions in which the push switch 1 should be used but are just shown there as an assistant to description and are insubstantial ones.

As shown in FIG. 1, the push switch 1 according to this embodiment includes the case 2, the fixed contact member 3 (including a first fixed contact member 31 and a second fixed contact member 32), the moving contact member 4, the protective sheets (including the first protective sheet 51 and the second protective sheet 52), and a presser 6. In the following description, unless otherwise stated, a state in which the push switch 1 is not operated, i.e., a state in which the push switch 1 is not pressed, will be described.

### <Case>

The case 2 has electrical insulation properties. The case 2 is made of a resin or a ceramic. The case 2 has the shape of a rectangular parallelepiped which is compressed in the upward/downward direction.

The case has the first surface 21, the second surface 22, the recess 23, and a plurality of (e.g., four in this embodiment) through holes 24.

The first surface 21 is one surface (upper surface) in a thickness direction defined with respect to the case 2. The first surface 21 is in a frame shape and is flat.

The second surface 22 is a surface (lower surface) located opposite from the first surface 21 (see FIG. 4). The second surface 22 is a rectangular surface. The second surface 22 is preferably flat. Note that the second surface 22 does not have to be flat entirely. Alternatively, the second surface 22 may have a step locally. In that case, the second surface 22 is preferably flat at least a partially between a portion corresponding to the outer peripheral edges of the second protective sheet 52 and the through holes 24 to be described later. That is to say, the second surface 22 is flat in areas thereof surrounding the through holes 24. Moreover, the second surface 22 is preferably flat at least in a portion thereof corresponding to the outer peripheral edges of the second protective sheet 52 to be described later.

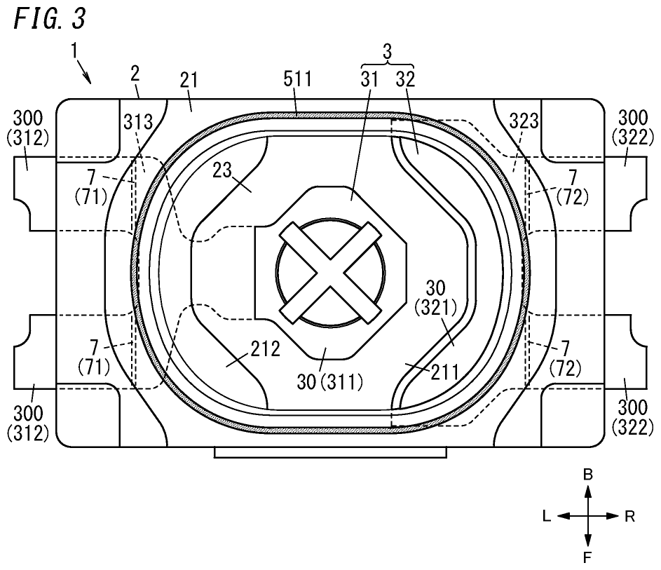

The recess 23 is open in the first surface 21. The recess 23 is formed in the shape of an oval which is longer in the rightward/leftward direction than in the forward/backward direction in a top view. The bottom surface 211 of the recess 23 is not flat but has varying depths. Specifically, the depth of the recess 23 is different between a central portion of the bottom surface 211 and the left and right outer peripheral portions thereof. The central portion of the bottom surface 211 is formed so as to be one step lower than the outer peripheral portions. The recess 23 is formed deeper in the central portion than in the outer peripheral portions. A support base 212 is provided in the left outer peripheral portion (see FIG. 3).

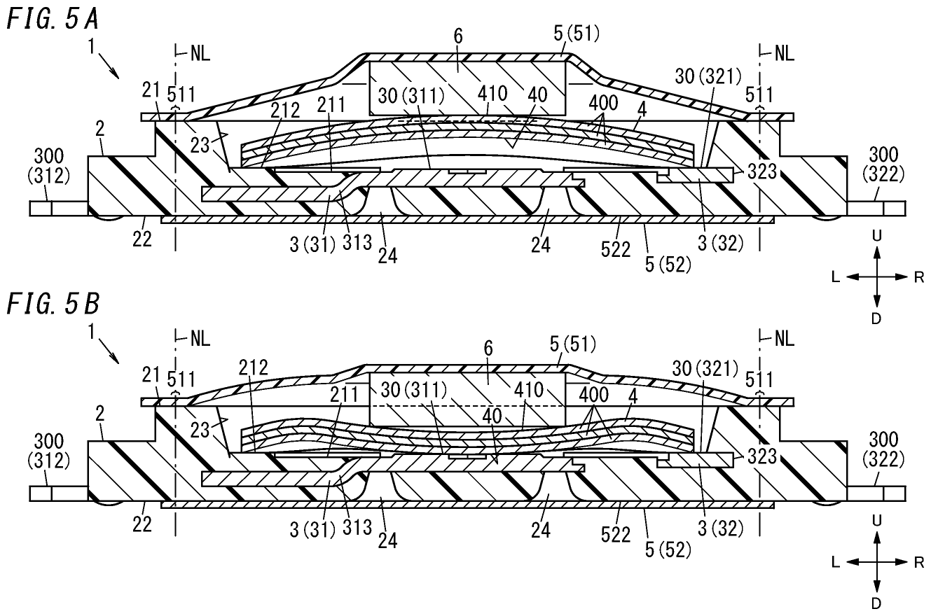

The through holes 24 are provided through the case 2. The through holes 24 are opened through the second surface 22. The through holes 24 make the fixed contact member 3 exposed through the second surface 22 of the case 2 (see FIGS. 5A and 5B). The through holes 24 are holes left by pulling out, after the case 2 has been formed, holding pins (not shown), which have been used while the case 2 is formed (during insert molding), for holding the fixed contact member 3.

### <Fixed Contact Member>

The fixed contact member 3 is held by the case 2. The fixed contact member 3 has electrical conductivity. For example, the fixed contact member 3 is formed of a metal plate. The fixed contact member 3 is integrated with the case 2 by insert molding, for example.

The fixed contact member 3 includes the fixed contacts 30, the terminals 300, and patterned surface structures 7. The fixed contacts 30 are arranged in the recess 23. The terminals 300 are arranged on the outer surfaces of the case 2. The patterned surface structures 7 are provided between the fixed contacts 30 and the terminals 300.

In this embodiment, the fixed contact member 3 includes the first fixed contact member 31 and the second fixed contact member 32 (see FIG. 3). The first fixed contact member 31 and the second fixed contact member 32 are arranged side by side in the rightward/leftward direction. The first fixed contact member 31 is arranged leftward of the second fixed contact member 32. The first fixed contact member 31 and the second fixed contact member 32 are electrically insulated from each other.

The first fixed contact member 31 includes a first fixed contact 311, a plurality of (e.g., two in this embodiment) first terminals 312, a first body portion 313, and first patterned surface structures 71.

The first fixed contact 311 is formed in a generally circular shape in a top view. The first fixed contact 311 is located in a central area of the bottom surface 211 of the recess 23. The first fixed contact 311 protrudes upward from the bottom surface 211 of the recess 23. In this manner, the first fixed contact 311 is exposed in the central area of the recess 23. The first fixed contact 311 is flush with the support base 212.

The first terminals 312 protrude leftward from the left side surface of the case 2. The respective lower surfaces of the first terminals 312 are flush with the second surface 22 of the case 2. The first terminals 312 are mechanically bonded and electrically connected, by soldering, to a conductive member on a printed circuit board, for example.

The first body portion 313 electrically connects the first fixed contact 311 and the first terminals 312. The first body portion 313 is a part embedded in the case 2.

The first patterned surface structures 71 are provided between the first fixed contact 311 and the first terminals 312. Specifically, the first patterned surface structures 71 are provided for the outer periphery of the first body portion 313. That is to say, the first patterned surface structures 71 are embedded in the case 2. The first patterned surface structures 71 may be formed by, for example, laser patterning. The first patterned surface structures 71 are formed before insert molding. If the first patterned surface structures 71 are formed by laser patterning, the material of the fixed contact member 3 is linearly scanned with a laser beam to connect a plurality of recesses with each other and thereby form a single groove. In this manner, the first patterned surface structures 71 are formed. In this case, the first patterned surface structures 71 are formed, across the fixed contact member 3, in a portion embedded in the case 2 of the fixed contact member 3. The first patterned surface structures 71 are traces left by laser patterning or traces left by laser irradiation. The first patterned surface structures 71 do not have to be formed by laser patterning. Alternatively, the first patterned surface structures 71 may also be formed by, for example, etching process or blasting process.

The second fixed contact member 32 includes a second fixed contact 321, a plurality of (e.g., two in this embodiment) second terminals 322, a second body portion 323, and second patterned surface structures 72.

The second fixed contact 321 is located along the right outer peripheral portion of the recess 23. The second fixed contact 321 protrudes upward from the bottom surface 211 of the recess 23. In this manner, the second fixed contact 321 is exposed on the right outer peripheral portion of the recess 23. In a top view, the second fixed contact 321 is line-symmetric to the support base 212 with respect to a center line drawn in the forward/backward direction. The second fixed contact 321 is flush with the first fixed contact 311 and the support base 212.

The second terminals 322 protrude rightward from the right side surface of the case 2. The respective lower surfaces of the second terminals 322 are flush with the second surface 22 of the case 2. The second terminals 322 are mechanically bonded and electrically connected, by soldering, to a conductive member on a printed circuit board, for example.

The second body portion 323 electrically connects the second fixed contact 321 and the second terminals 322. The second body portion 323 is a part embedded in the case 2.

The second patterned surface structures 72 are provided between the second fixed contact 321 and the second terminals 322. Specifically, the second patterned surface structures 72 are provided for the outer periphery of the second body portion 323. That is to say, the second patterned surface structures 72 are embedded in the case 2. The second patterned surface structures 72, as well as the first patterned surface structures 71, may be formed by laser patterning.

### <Moving Contact Member>

The moving contact member 4 is arranged in the recess 23 of the case 2. The moving contact member 4 is formed of a plate material having elasticity. For example, the moving contact member 4 is formed of a metal plate of stainless steel (SUS). The moving contact member 4 is formed by stacking a plurality of (e.g., three in this embodiment) leaf springs 400 having generally the same shape one on top of another.

The moving contact member 4 has a shape corresponding to the recess 23 and is formed one step smaller than the recess 23 so as to fall inside the recess 23. The moving contact member 4 is formed in the shape of an oval which is longer in the rightward/leftward direction than in the forward/backward direction in a top view. A central portion of the upper surface of the moving contact member 4 (upper surface of the uppermost leaf spring 400) constitutes a pressure receiving portion 410. When the push switch 1 is operated, the pressure receiving portion 410 receives force which is applied to the push switch 1 from outside of the push switch 1 (hereinafter referred to as “operating force”).

The moving contact member 4 is formed in a curved dome shape so that a central portion thereof is convex upward. In a state where the moving contact member 4 is housed in the recess 23, the four corners of the moving contact member 4 in a top view are in contact with the bottom surface 211 of the recess 23.

The moving contact member 4 includes the moving contact 40. The moving contact 40 is located in a central area of the lower surface of the moving contact member 4 (the lower surface of the lowermost leaf spring 400). Over the entire lower surface of the moving contact member 4, an electrically conductive film having electrical conductivity is formed by gold (Au) plating or silver (Ag) plating, for example. Of the electrically conductive film, a part corresponding to the central portion of the moving contact member 4 (pressure receiving portion 410) constitutes the moving contact 40.

In this embodiment, when the operating force is applied onto the pressure receiving portion 410, the moving contact member 4 is deformed, thus flexing the moving contact member 4 downward. The moving contact member 4 is deformed into a dome shape, of which the central portion is convex downward. At this time, the moving contact 40 that is formed on the lower surface of the pressure receiving portion 410 comes into contact with the first fixed contact 311, thus electrically connecting the moving contact 40 and the first fixed contact 311 to each other. The moving contact 40 is arranged in the recess 23 and comes into contact with the fixed contacts 30 in this manner as a result of the press operation.

The pressure receiving portion 410 is pushed toward the bottom surface 211 of the recess 23, thus deforming the moving contact member 4. This allows turning the switch ON/OFF. Specifically, when no operating force is applied onto the pressure receiving portion 410, the moving contact 40 is out of contact with the first fixed contact 311. Therefore, the switch is turned OFF. At this point in time, the first fixed contact member 31 and the second fixed contact member 32 are electrically insulated from each other, and therefore, the first terminals 312 and the second terminals 322 turn electrically non-conductive with each other. On the other hand, when the operating force is applied onto the pressure receiving portion 410 to bring the moving contact 40 into contact with the first fixed contact 311, the switch is turned ON. At this time, the first fixed contact member 31 and the second fixed contact member 32 are electrically connected via the moving contact member 4. Therefore, the first terminals 312 and the second terminals 322 turn electrically conductive with each other.

### <Protective Sheet>

The protective sheet 5 includes the first protective sheet 51 and the second protective sheet 52.

The first protective sheet 51 has flexibility, heat resistance, and electrical insulation properties. The first protective sheet 51 is, for example, a sheet made of a resin. The first protective sheet 51 covers the entire recess 23 provided in the first surface 21. As can be seen, the first protective sheet 51 is bonded to the first surface 21 of the case 2 to close the opening of the recess 23 and create a hermetically sealed state within the recess 23.

The outer peripheral shape of the first protective sheet 51 is generally the same as the outer peripheral shape of the first surface 21 of the case 2 and is one step larger than the first surface 21. The size of the first protective sheet 51 may be any appropriate size as long as the first protective sheet 51 is large enough to cover at least a bonding portion with respect to the case 2.

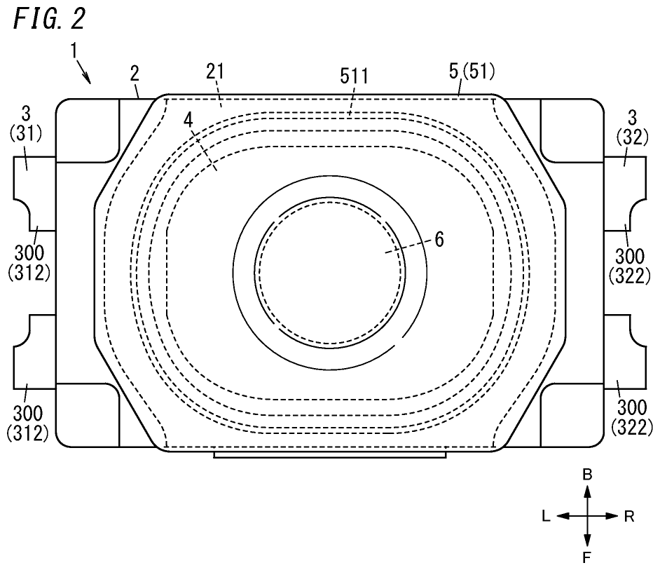

The bonding portion between the first protective sheet 51 and the case 2 is the first welded portion 511 (see FIG. 2). The first protective sheet 51 is welded to the first surface 21 of the case 2 with the first welded portion 511. As can be seen, the first welded portion 511 is provided between the first protective sheet 51 and the first surface 21. The first welded portion 511 is provided for the outer peripheral portion of the first protective sheet 51. The first welded portion 511 surrounds the entire circumference of the recess 23. The first welded portion 511 allows the first protective sheet 51 and a peripheral portion, surrounding the recess 23, of the first surface 21 to be bonded together.

The first welded portion 511 includes a melt pool. The melt pool is formed by melting and mixing a part of the first protective sheet 51 and a part of the case 2 with each other. The first welded portion 511 may be a laser welded portion or an ultrasonic welded portion. The laser welded portion is formed by laser welding. The ultrasonic welded portion is formed by ultrasonic welding.

The first welded portion 511 is located on a normal NL to the second protective sheet 52 (see FIGS. 5A and 5B). That is to say, in a top view, the first welded portion 511 is located in an area where the second protective sheet 52 is present.

The second protective sheet 52 has heat resistance and electrical insulation properties. The second protective sheet 52 may further have flexibility. The second protective sheet 52 is, for example, a sheet made of a resin. The second protective sheet 52 covers the entire second surface 22. In particular, the second protective sheet 52 covers the plurality of (e.g., four in this embodiment) through holes 24 opened through the second surface 22. As can be seen, the second protective sheet 52 is bonded to the second surface 22 of the case 2 to close the openings of the through holes 24 and create a hermetically sealed state within the through holes 24.

The outer peripheral shape of the second protective sheet 52 is generally the same as, for example, the outer peripheral shape of the second surface 22 of the case 2. The size of the second protective sheet 52 needs to be large enough to cover, in a top view, the bonding portion (first welded portion 511) between the first protective sheet 51 and the case 2.

The bonding portion between the second protective sheet 52 and the case 2 is the second welded portion 521 (see FIG. 4). The second protective sheet 52 is welded to the second surface 22 of the case 2 with the second welded portion 521. As can be seen, the second welded portion 521 is provided between the second protective sheet 52 and the second surface 22. In a top view, the second welded portion 521 is provided to cover the entire area where there is the second protective sheet 52. In this manner, the second welded portion 521 surrounds the entire circumference of each of the four through holes 24. The second welded portion 521 allows the second protective sheet 52 and the second surface 22 to be bonded together.

The second welded portion 521 includes a melt pool. The melt pool is formed by melting and mixing a part of the second protective sheet 52 and a part of the case 2 with each other. The second welded portion 521 may be, as well as the first welded portion 511, a laser welded portion or an ultrasonic welded portion.

The area of the second welded portion 521 is nearly equal to the area of one surface (surface facing the second surface 22 of the case 2) of the second protective sheet 52. Meanwhile, the area of the first welded portion 511 may be at most equal to the entire area of the first surface 21 surrounding the recess 23. Therefore, the area of the second welded portion 521 is larger than the area of the first welded portion 511. In addition, making the area of the second welded portion 521 larger than the area of the first welded portion 511 allows the second welded portion 521 to have a greater welding strength than the first welded portion 511.

### <Presser>

The presser 6 is arranged between the first protective sheet 51 and the pressure receiving portion 410 of the moving contact member 4. The presser 6 has electrical insulation properties. The presser 6 is made of, for example, a resin. The presser 6 has the shape of a disk which is compressed in the upward/downward direction. The presser 6 is arranged on the moving contact member 4 such that the lower surface of the presser 6 is in contact with the pressure receiving portion 410. The upper surface of the presser 6 is bonded to the lower surface of the central portion of the first protective sheet 51 by laser welding, for example.

The presser 6 transmits the operating force applied to the first protective sheet 51 to the pressure receiving portion 410 of the moving contact member 4. Specifically, when the operating force is applied onto the first protective sheet 51 from over the first protective sheet 51, the operating force is transmitted to the pressure receiving portion 410 via the presser 6 and acts on the pressure receiving portion 410 from over the pressure receiving portion 410. This allows the pressure receiving portion 410 to be indirectly operated via the presser 6 by having the first protective sheet 51 pressed.

### <Waterproof Measures>

Next, waterproof measures taken for the push switch 1 will be described. Note that in the following description, other advantages will also be described.

The following three routes are assumed as permeation routes of water (particularly, salt water), flux, and other foreign substances from the outside of the push switch 1 into the recess 23. A first permeation route is a route including the opening of the recess 23. A second permeation route is a route including the through holes 24. A third permeation route is a route including an interface between the case 2 and the terminals 300.

As waterproof measures taken for the first permeation route, the first protective sheet 51 is provided so as to cover the recess 23 in the first surface 21 of the case 2. The first welded portion 511 is provided between the first protective sheet 51 and the first surface 21 of the case 2, and therefore, the waterproofness of the push switch 1 may be improved. In this manner, the first protective sheet 51 may reduce the chances of water, flux, and other foreign substances entering the recess 23. This allows protecting the fixed contact member 3 and the moving contact member 4 that are housed in the recess 23 from water, flux, and other foreign substances. In addition, galvanic corrosion of members such as the fixed contact member 3 may be reduced.

Moreover, the first welded portion 511 may be a laser welded portion or an ultrasonic welded portion. This may reduce the deformation of the case 2. Using a pressure sensitive adhesive or an adhesive for bonding the first protective sheet 51 and the case 2 would cause the entire case 2 to be heated, thus possibly deforming the case 2.

Furthermore, as shown in FIGS. 5A and 5B, the first welded portion 511 is arranged on the normal NL to the second protective sheet 52. This allows improving the welding quality of the first welded portion 511. When the first protective sheet 51 is welded to the first surface 21 of the case 2, the case 2 is pressed downward from over the case 2. At this time, if the second protective sheet 52 is provided under the case 2, the second protective sheet 52 serves as a support, thus reducing the deformation such as declination of the case 2. In other words, the second protective sheet 52 may serve as an elastic material for absorbing shock. If the deformation of the case 2 is reduced in this manner, the first protective sheet 51 and the first surface 21 may be appropriately bonded with each other by welding. This allows improving the welding quality of the first welded portion 511.

As waterproof measures taken for the second permeation route, the second protective sheet 52 is provided for the second surface 22 so as to cover the through holes 24. The second welded portion 521 is provided between the second protective sheet 52 and the second surface 22, and therefore, the waterproofness of the push switch 1 may be improved. In this manner, the second protective sheet 52 may reduce the chances of water, flux, and other foreign substances entering the recess 23 through the through holes 24. This allows protecting the fixed contact member 3 and the moving contact member 4 that are housed in the recess 23 from water, flux, and other foreign substances. In addition, galvanic corrosion of members such as the fixed contact member 3 may be reduced.

Moreover, the second welded portion 521, as well as the first welded portion 511, may be a laser welded portion or an ultrasonic welded portion. This may reduce the deformation of the case 2. In this case, using a pressure sensitive adhesive or an adhesive for bonding the second protective sheet 52 and the case 2 would also cause the entire case 2 to be heated, thus possibly deforming the case 2.

Furthermore, the area of the second welded portion 521 is larger than the area of the first welded portion 511. The welding strength achieved by the second welded portion 521 between the second surface 22 of the case 2 and the second protective sheet 52 is greater than the welding strength achieved by the first welded portion 511 between the first surface 21 of the case 2 and the first protective sheet 51. This allows reducing, when the push switch 1 is mounted on a board by reflow soldering, the chances of the push switch 1 uplifting from the board.

Moreover, a guide path (recess) may be provided for guiding flux to the second surface 22 of the case 2. However, in this embodiment, the second surface 22 of the case 2 is flat. Since the second surface 22 is flat, almost the entire surface of the second protective sheet 52 may be brought into close contact with the second surface 22. As a result, the permeation route of substances such as flux may be blocked.

As waterproof measures taken for the third permeation route, the patterned surface structures 7 are provided between the fixed contacts 30 and the terminals 300. The patterned surface structures 7 cause an anchoring effect between the case 2 and the fixed contact member 3, thus improving adhesion between the case 2 and the fixed contact member 3. In this manner, the case 2 and the terminals 300 are brought into close contact with each other along their interface, thereby reducing the chances of water, flux, and other foreign substances entering the recess 23 of the case 2.

### <Operation>

Next, the operation of the push switch 1 will be described with reference to FIGS. 5A and 5B.

The push switch 1 is a normally open switch. That is to say, the push switch 1 turns ON only when the push switch 1 is operated. When the push switch 1 is operated, press operation is performed on the central portion of the first protective sheet 51 to cause downward operating force to be applied onto the presser 6 via the first protective sheet 51. As used herein, the “press operation” refers to the operation of pushing the central portion of the first protective sheet 51 toward the bottom surface 211 of the recess 23 (i.e., downward).

When the operating force is applied onto the pressure receiving portion 410 via the presser 6 from over the push switch 1, the pressure receiving portion 410 is pushed toward the bottom surface 211 (i.e., downward) of the recess 23, thus gradually deforming the moving contact member 4. Then, when the magnitude of the operating force that acts on the pressure receiving portion 410 exceeds a predetermined value, the moving contact member 4 is buckled with momentum and significantly deformed. At this time, the elastic force of the moving contact member 4 acting on the pressure receiving portion 410 changes sharply. As a result, through what is called “inversion operation” of the moving contact member 4, the moving contact member 4 is deformed into a curved dome shape so that the central portion (pressure receiving portion 410) thereof is convex downward. Consequently, the user performing the press operation on the push switch 1 is provided with clicking (a sense of click) as the moving contact member 4 is deformed. If the moving contact member 4 is deformed into a convex down, curved dome shape, the moving contact 40 comes into contact with the first fixed contact 311, thereby turning the switch ON (see FIG. 5B). In this state, the first terminals 312 and the second terminals 322 turn electrically conductive with each other.

Meanwhile, when the operating force is no longer applied to the pressure receiving portion 410 in a state where the moving contact member 4 is deformed into a convex down, curved dome shape, the central portion (the pressure receiving portion 410) of the moving contact member 4 restores (i.e., is deformed again into), with the force of restitution of the moving contact member 4, its original convex up, curved dome shape. At this time, the elastic force of the moving contact member 4 acting on the pressure receiving portion 410 changes sharply. Therefore, the moving contact member 4 dynamically restores, with momentum, (i.e., is deformed into) its original shape (i.e., a dome shape of which the central portion is convex upward). Consequently, the user who has been performing the press operation on the push switch 1 is provided, when he or she stops performing the press operation, with clicking (the sense of click), as the moving contact member 4 is deformed. When the moving contact member 4 restores the convex up dome shape, the moving contact 40 goes out of contact with the first fixed contact 311, thereby turning the push switch 1 OFF (see FIG. 5A). In this state, the first terminals 312 and the second terminals 322 turn electrically non-conductive with each other.

### (2.2) Second Embodiment

Next, a push switch 1 according to a second embodiment will be described. In the following description, any constituent element of this second embodiment, having the same function as a counterpart of the first embodiment described above, will not be described all over again to avoid redundancy. The case 2 of the second embodiment is different from the case 2 of the first embodiment.

In the second embodiment, the case 2 has a light-transmitting property. In other words, the case 2 has the property of transmitting visible light. The degree of transparency of the case 2 is not particularly limited. The case 2 may be colorless or colored as long as the case 2 is transparent or semitransparent. In addition, the case 2 has electrical insulation properties. The case 2 is made of a resin or a ceramic.

If a light source such as a light emitting element is arranged outside of the push switch 1, light emitted from the light source enters the case 2. Next, the light is propagated inside the case 2, and then emerges out of the case 2. In this manner, in the second embodiment, the case 2 functions as a light guide member. Therefore, the push switch 1 may be implemented as what is called an “illuminated switch.”

### (3) Variations

In the embodiment described above, the case 2 has the through holes 24. However, the case 2 does not have to have the through holes 24.

In the embodiment described above, the second welded portion 521 is present over almost the entire surface of the second surface 22. Alternatively, the second welded portion 521 may be distributed as a plurality of circular spot areas for the respective through holes 24 such that each circular spot area surrounds the entire circumference of an associated one of the through holes 24.

In the embodiment described above, the through holes 24 may be filled with a substance such as a resin, and the through holes 24 may be subjected to water-repelling treatment.

### (4) Recapitulation

As can be seen from the foregoing description of embodiments and their variations, the present disclosure has the following aspects. In the following description, reference signs are inserted in parentheses just for the sake of clarifying correspondence in constituent elements between the following aspects of the present disclosure and the exemplary embodiments described above.

A push switch (1) according to a first aspect includes a case (2), a fixed contact member (3), a moving contact member (4), a first protective sheet (51), and a second protective sheet (52). The case (2) has a first surface (21) with a recess (23) opened and a second surface (22) located opposite from the first surface (21). The fixed contact member (3) includes a fixed contact (30) arranged in the recess (23) and a terminal (300) arranged on an outer surface of the case (2). The moving contact member (4) is arranged in the recess (23) and includes a moving contact (40) that comes into contact with the fixed contact (30) when the push switch (1) is subjected to a press operation. The first protective sheet (51) is provided for the first surface (21) to cover the recess (23). The second protective sheet (52) covers the second surface (22). The first protective sheet (51) is welded to the first surface (21) of the case (2) with a first welded portion (511) surrounding an entire circumference of the recess (23). The second protective sheet (52) is welded to the second surface (22) of the case (2) with a second welded portion (521).

This aspect allows improving waterproofness of the push switch (1).

In a push switch (1) according to a second aspect, which may be implemented in conjunction with the first aspect, the case (2) is provided with a through hole (24) opened through the second surface (22) to make the fixed contact member (3) exposed through the second surface (22) of the case (2). The second protective sheet (52) covers the through hole (24).

This aspect allows reducing the chances of water (particularly, salt water) and/or flux entering the recess (23) of the case (2) through the through holes (24).

In a push switch (1) according to a third aspect, which may be implemented in conjunction with the second aspect, the second welded portion (521) surrounds an entire circumference of the through hole (24).

This aspect allows further reducing the chances of foreign substances such as water entering the through hole (24).

In a push switch (1) according to a fourth aspect, which may be implemented in conjunction with any one of the first to third aspects, the second welded portion (521) is a laser welded portion formed by laser welding or an ultrasonic welded portion formed by ultrasonic welding.

This aspect allows reducing deformation of the case (2).

In a push switch (1) according to a fifth aspect, which may be implemented in conjunction with any one of the first to fourth aspects, the first welded portion (511) is located on a normal (NL) to the second protective sheet (52).

This aspect allows improving the welding quality of the first welded portion (511).

In a push switch (1) according to a sixth aspect, which may be implemented in conjunction with any one of the first to fifth aspects, an area of the second welded portion (521) is larger than an area of the first welded portion (511).

This aspect allows reducing, when the push switch (1) is mounted on a board by reflow soldering, the chances of the push switch (1) uplifting from the board.

In a push switch (1) according to a seventh aspect, which may be implemented in conjunction with any one of the first to sixth aspects, a welding strength achieved by the second welded portion (521) between the second surface (22) of the case (2) and the second protective sheet (52) is greater than a welding strength achieved by the first welded portion (511) between the first surface (21) of the case (2) and the first protective sheet (51).

This aspect allows reducing, when the push switch (1) is mounted on a board by reflow soldering, the chances of the push switch (1) uplifting from the board.

In a push switch (1) according to an eighth aspect, which may be implemented in conjunction with any one of the first to seventh aspects, the second surface (22) of the case (2) is flat.

This aspect allows blocking a permeation route of foreign substances such as flux.

In a push switch (1) according to a ninth aspect, which may be implemented in conjunction with any one of the first to eighth aspects, the fixed contact member (3) further includes a patterned surface structure (7) provided between the fixed contact (30) and the terminal (300).

This aspect allows reducing the chances of water (particularly, salt water) and/or flux entering the recess (23) of the case (2) through an interface between the case (2) and the fixed contact member (3).

### REFERENCE SIGNS LIST

1 Push Switch

2 Case

21 First Surface

22 Second Surface

23 Recess

24 Through Hole

3 Fixed Contact Member

30 Fixed Contact

300 Terminal

4 Moving Contact Member

40 Moving Contact

51 First Protective Sheet

511 First Welded Portion

52 Second Protective Sheet

521 Second Welded Portion

7 Patterned Surface Structure

NL Normal

1. A push switch comprising:
a case having a first surface with a recess opened and a second surface located opposite from the first surface;
a fixed contact member including a fixed contact arranged in the recess and a terminal arranged on an outer surface of the case;
a moving contact member arranged in the recess and including a moving contact configured to come into contact with the fixed contact when the push switch is subjected to a press operation;
a first protective sheet provided for the first surface to cover the recess; and
a second protective sheet covering the second surface,
the first protective sheet being welded to the first surface of the case with a first welded portion surrounding an entire circumference of the recess,
the second protective sheet being welded to the second surface of the case with a second welded portion.

2. The push switch of claim 1, wherein
the case is provided with a through hole opened through the second surface to make the fixed contact member exposed through the second surface of the case, and
the second protective sheet covers the through hole.

3. The push switch of claim 2, wherein
the second welded portion surrounds an entire circumference of the through hole.

4. The push switch of claim 1, wherein
the second welded portion is a laser welded portion formed by laser welding or an ultrasonic welded portion formed by ultrasonic welding.

5. The push switch of claim 1, wherein
the first welded portion is located on a normal to the second protective sheet.

6. The push switch of claim 1, wherein
an area of the second welded portion is larger than an area of the first welded portion.

7. The push switch of claim 1, wherein
a welding strength achieved by the second welded portion between the second surface of the case and the second protective sheet is greater than a welding strength achieved by the first welded portion between the first surface of the case and the first protective sheet.

8. The push switch of claim 1, wherein
the second surface of the case is flat.

9. The push switch of claim 1, wherein
the fixed contact member further includes a patterned surface structure provided between the fixed contact and the terminal.
